(19) United States
(12) Patent Application Publication
(10) Pub. No.: US 2013/0112069 A1
(43) Pub. Date: May 9, 2013

(54) Apparatus And Method To Transform Stringed Musical Instrument Vibrations

(71) Applicants: Gabriel Weinreich, Chelsea, MI (US); Walter Joseph Curtin, Ann Arbor, MI (US); John Langdon Bell, Naperville, IL (US); Alexander Sobolev, West Bloomfield, MI (US)

(72) Inventors: Gabriel Weinreich, Chelsea, MI (US); Walter Joseph Curtin, Ann Arbor, MI (US); John Langdon Bell, Naperville, IL (US); Alexander Sobolev, West Bloomfield, MI (US)

(21) Appl. No.: 13/291,069

(22) Filed: Nov. 7, 2011

(51) Int. Cl. G10H 3/18

(52) U.S. Cl. 84/731

(57) ABSTRACT

An apparatus and method to accept signals from an electrical stringed musical instrument (ESMI) and transform them into corresponding sounds as they would be created by an acoustic stringed musical instrument (ASMI). The apparatus and method comprise an ESMI, a method of capturing the tonal characteristics of an ASMI, a method of recreating the ASMI's tonal characteristics from the ESMI, and a means of emulating directional tone color (DTC) with various amplification systems.

### FIELD OF THE INVENTION

The present disclosure is in the technical field of stringed musical instruments. More particularly, the present disclosure focuses on transforming the vibration generated by an electrical stringed musical instrument, such as an electric violin, into sound which emulates the output from an acoustic instrument, such as an acoustic violin.

### BACKGROUND OF THE INVENTION

Currently, numerous electrical musical instruments transform instrument string vibrations into sound. Examples include electric guitars and electric violins.

### BRIEF SUMMARY OF THE INVENTION

The present disclosure provides an apparatus and method to transform stringed musical instrument vibrations. The apparatus and method comprise an electrical stringed musical instrument (ESMI), a method of capturing the tonal characteristics of an acoustical stringed musical instrument (ASMI), a method of recreating the ASMI's tonal characteristics from the ESMI, and a means of emulating directional tone color (DTC) with various amplification systems. The electrical stringed instrument comprises: a plurality of strings; a bridge with a plurality of feet on which the plurality of strings is functionally attached; a pickup platform on which the bridge is functionally attached, the pickup platform comprising: damping means, a mass, and a piezoelectric transducer, hereafter referred to as “piezo,” for each bridge foot; a structure to hold the damping means, mass, and piezos; an analog preamplifier which accepts analog output from the piezos; an analog to digital converter which transforms the analog preamplifier signal to a digital signal; and transmission means for the digital signal. The computing environment converts the digital signal to a new signal using a set of impulse responses (IRs) created from an ASMI. This signal corresponds to the sound of the same player playing the original ASMI in precisely the same way as the ESMI. A novel approach to capturing the ASMI's tonal characteristics using a measurement rig is used to generate the IRs. Depending on the means of playback to be used, a number of options are used to introduce DTC including, but not limited to, multi-channel output configurations, and a specially designed loudspeaker system.

The apparatus allows a user to use their preferred strings. The strings are the sound source. The strings can be plucked, bowed, or the like. The vibrating strings create a force on the bridge.

The bridge holds the strings in place and transfers string vibration to the pickup platform at the bridge feet.

One piezo is attached to each bridge foot. The piezos convert the vibration force at the bridge feet to electrical signals.

The mass transfers residual vibration from the piezos to the damping means.

Damping means can be urethane foam or the like. The combination of the mass and damping means serves to drain energy from the strings in a similar way to an ASMI. It also decouples the energy in the bridge from the rest of the support structure.

The analog to digital converter has a large dynamic range.

Transmission means for the digital signal can be wired or wireless.

The computing environment includes a processor as, for example, a field-programmable gate array (FPGA).

The amplification system can be a live sound system, recording system, home sound system, headphones, or the like.

The method to transform stringed musical instrument vibrations comprises: playing an ESMI, sending a corresponding signal to a computing environment, and amplifying a signal from the computing environment with an amplification system.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a block diagram of a typical computing environment used for implementing embodiments of the present disclosure.

FIG. 2 is a functional diagram with a cross-section view of a stringed musical instrument.

FIG. 3 is a cross-section view of a violin embodiment with a v-shaped internal bottom, as described in this disclosure.

FIG. 4 is a block diagram showing elements of an apparatus embodiment.

FIG. 5 is a detail block diagram showing convolution processing.

### DETAILED DESCRIPTION OF THE INVENTION

The sound output of an acoustic stringed musical instrument (ASMI) such as a violin is determined by the acoustical response of the instrument body to the fluctuating forces exerted upon it by the bowed string via the bridge. In normal use, the body vibrates within its linear range, and so the acoustical output can be represented by a set of impulse responses. An impulse response, or IR, is the response of a system to a short, sharp impact; it is the time-domain equivalent of a complex frequency response function. Each IR is characterized by (1) a specific driving point on the violin bridge; (2) a direction of excitation (e.g., horizontal or vertical with respect to the plane of the top of the instrument), and (3) the position (with respect to the instrument body) of the microphone used to sample the resulting sound field.

This disclosure describes a means of using what will be called horizontal and vertical IRs from an ASMI in order to emulate its sound output by means of digital manipulation of the string signal from an electric stringed musical instrument (ESMI). In practice, this requires:

1) A Means of Capturing the Relevant Tonal Characteristics of the ASMI:

A standard way of measuring an ASMI's impulse response makes use of an impact hammer—a standard engineering tool with a piezo force sensor in its tip. The ASMI is suspended in such a way that the impact hammer can tap the bridge at predetermined points and in predetermined directions. The acoustical response of the ASMI is sensed by a microphone, which can be placed at various positions with respect to the instrument. The microphone signal is divided by the hammer signal (in the frequency domain), and the resulting signal saved as an IR.

This disclosure describes a means of emulating the acoustical response of an ASMI by using both horizontal and vertical IRs—by which is meant, IRs derived from the ASMI's response to both horizontal and vertical driving forces. The horizontal IR is measured by tapping the bass corner of the bridge sideways, i.e., in a direction parallel to the plane of the top of the ASMI. The vertical IR is measured by tapping downward at the top center of the bridge—i.e., in a direction normal to the plane of the top of the ASMI.

2) A Player Interface:

The player interface must:

A) be capable of producing the characteristic driving force of the ASMI (e.g., the bowed string, in the case of violin), and then translating these fluctuating mechanical forces into correspondingly fluctuating electrical signals.

B) have as flat a frequency response as possible, in order that the signal not be arbitrarily colored by the vibrational response of the interface itself. (In practice, if the response is reasonably flat and without nulls, the frequency response of the interface can be measured, then inverted, allowing any deviations to be corrected by normal signal processing techniques.)

C) have a bridge with sufficient general mobility to (1) drain energy from the vibrating string at about the rate as does the ASMI it seeks to emulate, and (2) allow strings to vibrate sympathetically with one another.

Conditions (B) and (C) tend to be mutually exclusive, since bridge mobility will have a frequency dependence related to the vibrational modes of the structure of the interface.

This disclosure describes a novel way of achieving both a relatively flat frequency response, and an appropriate amount of bridge mobility. It does so as follows: the bridge of the interface rests on a mass/spring system whose lowest modes of vibration are at least an octave below the frequency range of interest of the ASMI being emulated. This is achieved by having the platform consist of a mass that is relatively large compared with that of the bridge. This mass rests on a springy material of appropriate stiffness and damping. The characteristics of the mass/spring system are arranged so that (1) the general mobility of the bridge is at a satisfactory level; (2) the system's vibrational modes are either below or above the ASMI's frequency range of interest, and (3) the damping is sufficient to smooth out any sharp peaks or dips in the frequency response of the interface.

3) A Means of Recreating the Characteristics of the ASMI from the User Interface:

The transformation from electrical signal into acoustical signal is performed by the convolution of the electrical signal with the appropriate IRs. Because this must happen in real-time—i.e., with delays of less than a few milliseconds—the length of the IRs precludes the use of the most common method of convolution (that is, through the use of Fast Fourier Transforms), as the propagation delay would be—at minimum—equal to the length of the IR which is unacceptably large. Thus, a brute-force method must be adopted and a parallel processing scheme in which each convolution processor itself has the ability to process multiple data streams at once is necessary to handle the sheer quantity of data required to be processed for such methods.

The transformation from an electrical to an acoustical signal must furthermore translate the force signals from the interface into a response equivalent to the acoustical output of the ASMI, as captured by the horizontal and vertically measured IRs.

In order to do this, it must first be able to link the electrical output of each bridge foot to the ASMI's horizontal and vertical IRs. Since the electrical outputs from the player interface are not precisely the same as the driving forces used to create the horizontal and vertical IRs, it becomes necessary to create new IRs using the same horizontal and vertical driving forces as before, but with each piezo's electrical signal as the output (in place of the microphone). Thus, we now have four IRs (to be called “Calibration IRs”): one for each combination of driving force (horizontal/vertical) and output (bass/treble piezos). When the electrical signal from each piezo is divided by the appropriate calibration IR (in the frequency domain) and the outputs of each are summed, it is possible to show that the frequency response of this system to either a horizontal or a vertical driving force is flat and thus can be linked to the ASMI's horizontal and vertical IRs.

The transformation must furthermore combine the calibration IRs with the ASMI's IRs, condensing them into two final IRs that can be used by the convolution processors. This is done by arranging them in series and using two well-known concepts in systems theory to combine them: IRs in series get multiplied (in the frequency domain) and parallel branches get summed

In this manner we end up with two responses, a “vertical” and a “horizontal”. However, by low-pass filtering the two outputs and comparing their amplitudes, we can also obtain information about the angle at which the string is being bowed. We can then use this information, again in real time, to mix the vertical and horizontal outputs in the correct proportion.

It is also possible for IRs to be changed in real-time, in the way an electric guitarist switches one effect for another. In this case, of course, changing a set of IRs would be similar to instantly putting down one instrument and picking up a new one with different tonal characteristics.

4) A Means of Reproducing an ASMI's Directional Tone Color:

It is known that the sound radiation of an ASMI becomes extremely complex at high frequencies. With a violin, for example, above about 1,000 Hz the radiation patterns begin to vary rapidly with frequency, typically changing drastically from one semitone to the next. Directivity becomes so pronounced that the individual partials of played notes radiate in “quill-like” beams. The shifts in frequency within a vibrato cycle are sufficient to cause the direction of these beams to vary—and to do so independently of one another. This creates a “directional modulation” of partials during vibrato that adds to the frequency modulation. The overall effect is too complex to be perceived by the ear for what it is. Instead, it is heard as directional tone color (DTC), which contributes to the characteristic sound quality of an ASMI, and affects the way that sound seems to fill space. Because normal loudspeakers are designed for minimal directivity, they tend to strip DTC from the recorded sound of an ASMI.

This disclosure describes several methods for emulating the DTC of the ASMI when using (1) conventional sound reproduction devices such as headphones and loudspeakers; (2) multi-speaker systems such as Surround Sound, and (3) a loudspeaker system that creates DTC by novel means.

For conventional sound reproduction systems (1), the process described for capturing an ASMI's tonal characteristics is repeated at least once using a different microphone position. In the case that two microphone positions are used, each is sent to opposite playback channels (L&R), thus utilizing the stereo listening environment to recreate a portion of the instrument's DTC. Note that there are infinite possibilities for microphone positions. Standard coincident and near-coincident configurations used by recording professionals are possible (such as X-Y, ORTF, and NOS) but choices are in no way limited to these. In the case of more than two microphone positions, the microphone are mixed to 2 channels as so desired.

For multi-speaker systems (2), multiple microphone positions are used as mentioned above. However, the extra outputs (L and R surround, for example) are typically attenuated as so desired to maintain a stable forward image.

In (3), a specially designed loudspeaker system is used to recreate DTC in a novel way. A low- to mid-frequency driver is used to reproduce frequencies that an ASMI typically radiates omnidirectionally. Higher frequencies are reproduced using an array of high-frequency drivers arranged so their coverage patterns overlap maximally while the sum of the coverage patterns covers nearly 360 degrees. The signals sent to each of the high-frequency drivers are modified independently by a series of all-pass filters. These filters alter the phase of the signal at specific frequencies. When the modified signals from neighboring high-frequency drivers interact in the space around the loudspeaker, the resulting constructive and destructive interference creates large nulls and beams. Because the phase of the signals now vary with frequency, these nulls and beams also vary with frequency. In this way, the DTC created by an acoustic instrument's complex soundfield is emulated.

Additionally, since a large number of all-pass filters in series will tend to smear transients at frequencies other than those intentionally modified, it becomes important to minimize the number of series all-pass filters. In order to achieve this, the signal sent to each high-frequency driver is first broken up into bands using band-pass filters 453. Then, the same all-pass filters are distributed among each frequency band and finally the bands are summed and the resulting signal sent to the appropriate driver. In this way, the number of series all-pass filters is limited to the maximum number in any one frequency band, rather than being aggregated over the full spectrum.

The present disclosure discusses an apparatus and method to transform the user generated electrical stringed instrument signals into corresponding acoustic sounds at user selectable volumes. The apparatus and method replace the generated vibrations with acoustic sounds governed by a set of measured impulse responses (IR's) of a specific ASMI. These IR's are created with a corresponding acoustic instrument and measurement rig.

The measurement rig comprises: an impact hammer, microphone, and computing environment, each of which are commercially available.

The impact hammer contains a small piezo in the tip. So when the impact hammer strikes the bridge, the applied force is proportional to the piezo voltage.

The microphone receives the sound produced when the impact hammer taps the bridge.

The measurement rig computing environment analyzes and stores the sound data received by the microphone as well as the force data supplied by the hammer. The data is processed and stored for use in the apparatus and method described in the present disclosure.

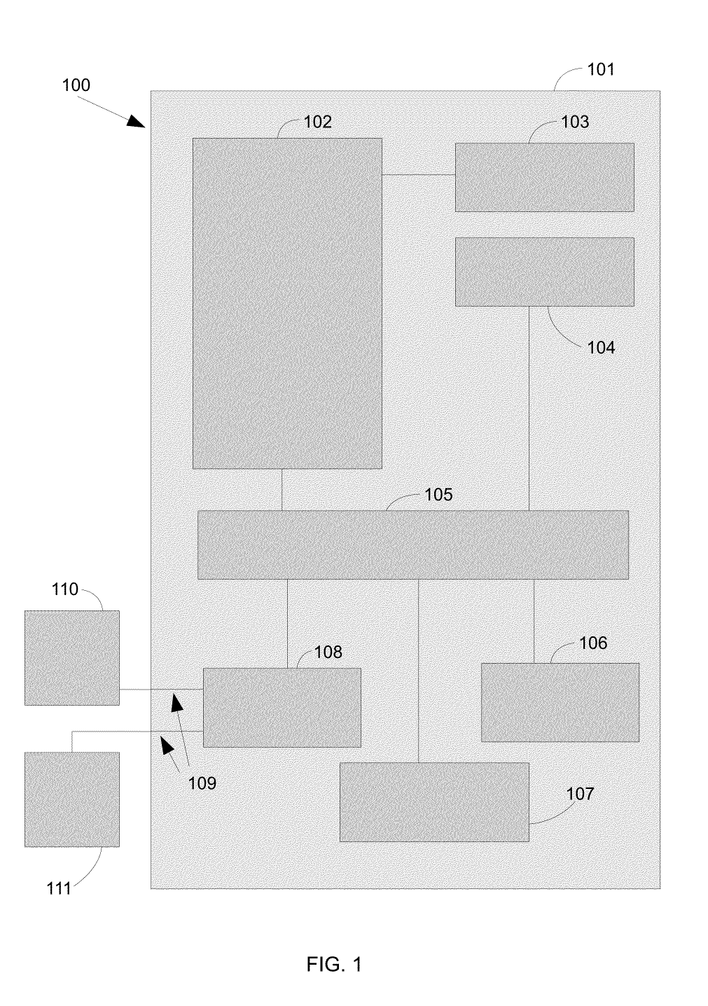

FIG. 1 is a block diagram of a typical computing environment used for implementing embodiments of the present disclosure. FIG. 1 and the following discussion are intended to provide a brief, general description of a suitable computing environment in which certain embodiments of the present disclosure may be implemented.

FIG. 1 shows a computing environment 100, which can include but is not limited to, a housing 101, processing unit 102, volatile memory 103, non-volatile memory 104, a bus 105, removable storage 106, non-removable storage 107, a network interface 108, ports 109, a user input device 110, and a user output device 111.

Various embodiments of the present subject matter can be implemented in software, which may be run in any suitable computing environment. The embodiments of the present subject matter are operable in a number of general-purpose or special-purpose computing environments. Some computing environments include personal computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments, analyzers designed to read multiple inputs from a critical care patient, and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

A general computing device, in the form of a computer, may include a processor, memory, removable storage, non-removable storage, bus, and a network interface.

A computer may include or have access to a computing environment that includes one or more user input modules, one or more user output modules, and one or more communication connections such as a network interface card or a USB connection. The one or more output devices can be a display device of a computer, computer monitor, TV screen, plasma display, LCD display, display on a digitizer, display on an electronic tablet, and the like.

The computer may operate in a networked environment using the communication connection to connect one or more remote computers. A remote computer may include a personal computer, server, router, network PC, a peer device or other network node, and/or the like. The communication connection may include a Local Area Network (LAN), a Wide Area Network (WAN), and/or other networks.

Memory may include volatile memory and non-volatile memory. A variety of computer-readable media may be stored in and accessed from the memory elements of a computer, such as volatile memory and non-volatile memory, removable storage and non-removable storage. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, memory sticks, and the like. Memory elements may also include chemical storage, biological storage, and other types of data storage.

“Processor” or “processing unit” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a graphics processor, a digital signal processor, field-programmable gate array (FPGA), or any other type of processor or processing circuit. The term also includes embedded controllers, such as generic or programmable logic devices or arrays, application specific integrated circuits, single-chip computers, smart cards, and the like.

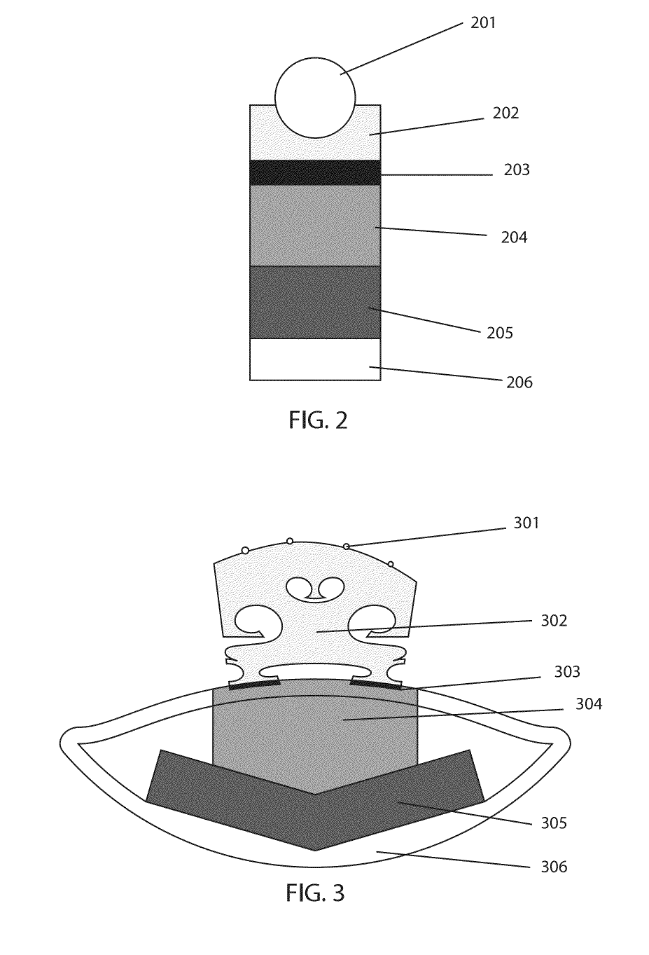

FIG. 2 is a functional diagram with a cross-section view of a stringed musical instrument. A vibration is transferred from a vibration source 201 such as a string to a vibration source support structure 202 such as a bridge. The vibration source support structure 202 transfers the force to a sensor 203 such as a piezo. The sensor 203 creates an electrical signal and also transfers force to a mass 204. The mass 204 transfers force to a damping material 205. The sensor 203, mass 204, and damping material 205 comprise a pick-up platform. A support structure for the pickup platform 206 supports the damping material 205.

FIG. 3 is a cross-section view of a violin, as described in this disclosure. Strings 301 transfer force to a bridge 302. The bridge transfers force to piezos 303. The piezos 303 generate an electrical signal and transfer force to a mass 304. The mass transfers force to a damping material 305. A support structure for the pickup platform 306 supports the damping material 305.

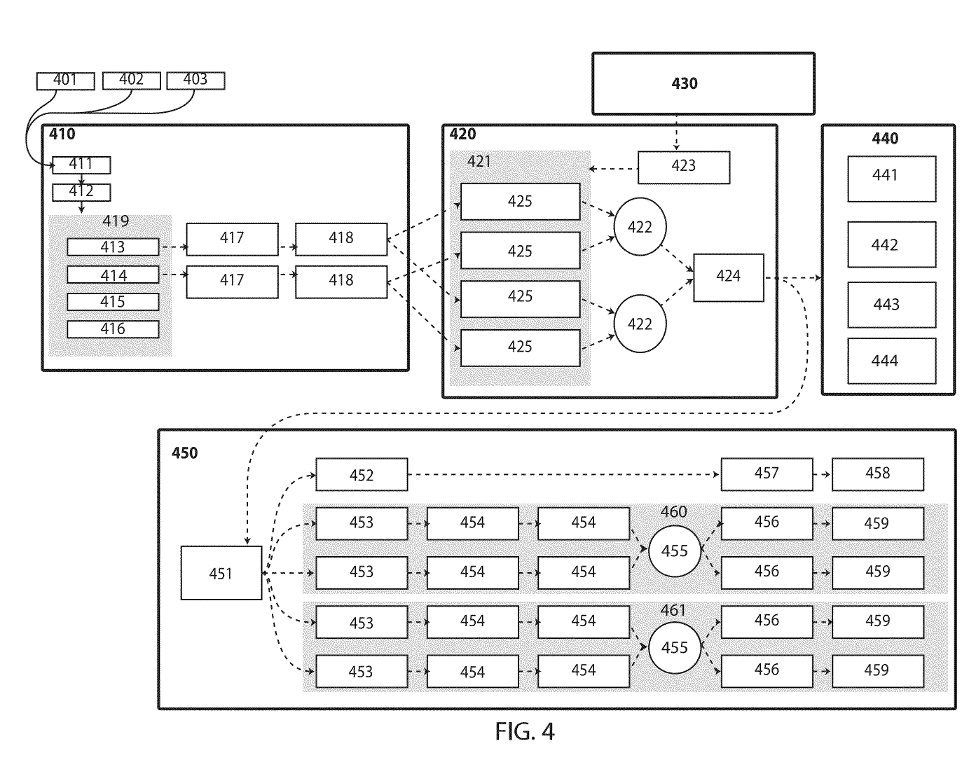

FIG. 4 is a block diagram showing elements of an apparatus embodiment. A bow 401, plectrum 402, or finger 403 is used to exert force upon a string 411 of an ESMI 410. The string 411 transfers the force to a bridge 412. The bridge 412 transfers the force to a pick-up platform 419, which comprises a bass piezo 413, treble piezo 414, mass 415, and damping 416. The bass piezo 413 and treble piezo both send an electrical signal to analog preamplifiers 417, which send electrical signals to analog-to-digital converters 418. The resulting digital signals are sent to a digital controller 420, which comprises processing means 421, summation means 422, voice selection means 423, and an output mixer 424. The voice selection means 423 receives an electrical signal from an external computing device 430 such as a personal computer, tablet computer, mobile device, or the like. The voice selection means 423 then sends an electrical control signal to the digital controller 421. The digital controller 421 performs convolution processing 425 on the signal from the analog to digital converter and outputs a digital signal to summation means 422, which then sends a signal to an output mixer 424. The output mixer 424 can send an electrical signal to an external amplification system 440 or DTC speaker 450. The amplification system 440 can include, but is not limited to: a live sound system 441, recording system 442, home sound system 443, and headphones. The DTC speaker 450 accepts an electrical signal with either a wired or wireless audio receiver 451. The audio receiver 451 splits the signal, sending it to a low-pass filter 452, a first channel 460, and a second channel 461. The channels accept the electrical signal with band-pass filters 453, which send electrical signals to a series of all-pass filters 454. The output from the all-pass filters 454 is sent to summation means 455, which sends electrical signals to channel amplifiers 456. The channel amplifiers 456 send electrical signals to wide-band tweeters 459. The low-pass filter 452 sends an electrical signal to an amplifier 457, which sends an electrical signal to a mid-range woofer 458.

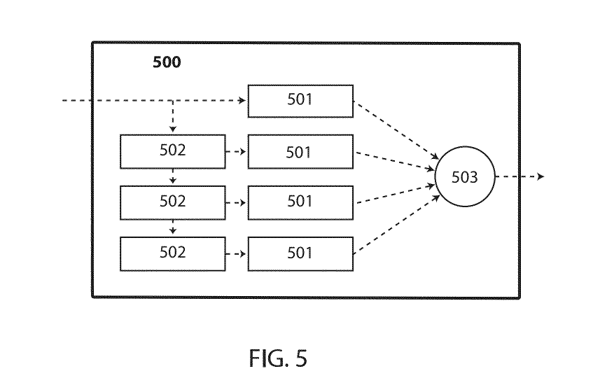

FIG. 5 is a detail block diagram showing convolution processing. An electrical signal enters the convolution processing area 500, where it goes to several finite impulse response filters 501 in parallel with individual input signal delays 502. The resulting electrical signal undergoes summation means 503 and then an electrical signal is sent out of the convolution processing area 500.

Embodiments of the present subject matter may be implemented in conjunction with program modules, including functions, procedures, data structures, application programs, etc. for performing tasks, or defining abstract data types or low-level hardware contexts.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

We claim:

1. An apparatus to transform stringed musical instrument vibrations, the apparatus comprising:
an ESMI, which comprises:
a plurality of strings;
a bridge with a plurality of legs on which the plurality of strings is functionally attached;
a pickup platform on which the bridge is functionally attached, wherein the pickup platform is configured such that its vibrational modes are either above or below an ASMI's frequency range of interest, the pickup platform comprising:
damping means,
a mass, and
a piezo under each bridge leg;
a body to hold the damping means, mass, and piezos;
an analog preamplifier which accepts analog output from the piezos;
an analog to digital converter which transforms the analog preamplifier signal to a digital signal; and
transmission means for the digital signal;
a computing environment which converts the digital signal to a signal governed by a set of IRs, corresponding to a specific acoustic instrument, and outputs the converted signal; and
an amplification system which accepts the converted signal and scatters it in three dimensions in a manner similar to theme ASMI's natural directional tone color.

2. The apparatus of claim 1, further comprising a loudspeaker enclosure, which comprises:
one low-mid frequency driver;
a plurality of high frequency drivers arranged so their directivity patterns overlap;
a computing environment comprising:
a plurality of low-pass, band-pass, and high-pass filters for frequency distribution and all-pass filters; and
power amplifiers suitable to operate the low-mid and high-frequency drivers.

3. The apparatus of claim 1, wherein the damping means consists essentially of urethane foam.

4. The apparatus of claim 2, wherein the damping means consists essentially of urethane foam.

5. The apparatus of claim 1, wherein the bridge weighs less than the mass.

6. The apparatus of claim 2, wherein the bridge weighs less than the mass.

7. The apparatus of claim 3, wherein the bridge weighs less than the mass.

8. The apparatus of claim 4, wherein the bridge weighs less than the mass.

9. A method to more completely capture an ASMI's tonal characteristics and recreate them using an ESMI, the method comprising:
measuring an acoustic instrument with a combination of excitations that, together, captures the AMSI's tonal characteristics.;
playing an ESMI, the ESMI comprising:
a plurality of strings;
a bridge with a plurality of legs on which the plurality of strings is functionally attached;
a pickup platform on which the bridge is functionally attached, wherein the pickup platform is configured such that its vibrational modes are either above or below the ASMI's frequency range of interest, the pickup platform comprising:
damping means,
a mass, and
a piezo under each bridge leg;
a body to hold the damping means, mass, and piezos;
an analog preamplifier which accepts analog output from the piezos;
an analog to digital converter which transforms the analog preamplifier signal to a digital signal; and
transmission means for the digital signal;
sending a signal corresponding to the force created at each bridge foot by the vibrating strings to a computing environment, which converts the digital signal to a new signal using a set of IRs which correspond to a specific acoustic instrument ; and
amplifying the signal from the computing environment with an amplification system at a user selected volume.

10. The method claimed in 9, wherein the amplification step further comprises:
using all-pass filters in combination with acoustic interference patterns to create a soundfield that changes rapidly over space and frequency in an effort to emulate the DTC of acoustic instruments.

11. The method claimed in 9, wherein the measurement step further comprises:
using multiple microphone positions and mixing methods to capture and reproduce a specific ASMI's DTC.

12. The apparatus of claim 9, wherein the damping means consists essentially of urethane foam.

13. The apparatus of claim 10, wherein the damping means consists essentially of urethane foam.

14. The apparatus of claim 11, wherein the damping means consists essentially of urethane foam.

15. The apparatus of claim 9, wherein the bridge weighs less than the mass.

16. The apparatus of claim 10, wherein the bridge weighs less than the mass.

17. The apparatus of claim 11, wherein the bridge weighs less than the mass.

18. The apparatus of claim 12, wherein the bridge weighs less than the mass.

19. The apparatus of claim 13, wherein the bridge weighs less than the mass.

20. The apparatus of claim 14, wherein the bridge weighs less than the mass.
